(19) United States
(12) Patent Application Publication
(10) Pub. No.: US 2012/0256490 A1
(43) Pub. Date: Oct. 11, 2012

(54) Integrated Expandable Grid-Ready Solar Electrical Generator

(76) Inventor: Yongchun Zheng, Newtown, CT (US)

(21) Appl. No.: 13/082,391

(22) Filed: Apr. 7, 2011

(51) Int. Cl. H02J 3/38

(52) U.S. Cl. 307/52

(57) ABSTRACT

The generator of the present invention is a complete 220V or 120V AC solar electrical generator that is ready to be directly connected to utility power grid, and more than one of the generators can be connected in parallel to power the grid or to power an isolated electrical system. The generator is integrated with a solar panel that converts solar energy into electrical energy, a Max Power Point Tracking (MPPT) controller that dynamically adjust the output power of the generator to maximize the power of the solar energy, a high efficiency low harmonic digital signal process (DSP) technology based synthetic DC to AC converter that provides 220V or 120V AC power, a synchronizing controller that enables the generator to be connected to the utility power grid or connected to other generators, a power factor compensation unit that reduces the reactive power to improve power quality, a protection unit to prevent the generator from hazardous accident, an energy meter that measures the energy generated by the solar panel and the energy feed into the utility power grid, and a communication unit that sends the parameters such as the voltage, the current, the temperature of the solar panel, the efficiency and related data of MPPT, the timing of AC power and the other information about the generator to the other generators and central controller and receives the information and control commands from the other generators and central controller through AC wire or wirelessly. The generator can be optionally to be equipped with proper battery for some isolated applications.

### BACKGROUND OF THE INVENTION

1. Field of the Invention

The present invention relates to solar electrical power generator, and specifically to an integrated solar electrical generator that can be directly tied to utility power grid, or can work as standalone or tied with more of the same generators as group to provide isolated 220V or 120V AC power source.

2. Description of Related Patents

A typical solar electric power generator comprises a number of solar panels arranged in series and parallel configuration to supply about 3 KW to 5 KW power to a central MPPT controller, then to a DC to AC converter, commonly called an inverter, and finally to a grid-tie unit.

The following U.S. patents relate generally to the state of the art in photovoltaic electricity systems.

U.S. Pat. No. 6,201,180 to Meyer presents an Integrated Photovoltaic System that comprises a group of solar panels and a DC to AC power inverter. The solar panels are connected together with a DC bus-wire. The DC power generated with the solar panels is then fed into a DC to AC inverter. It is a typical centralized solar electrical generator with multiple solar panels

U.S. Pat. No. 6,111,189 to Garvison presents a Photovoltaic Module Frame System with Integral Electrical Raceways that provides infrastructure for the centralized solar electricity system.

U.S. Pat. No. 6,285,572 to Onizuka presents a Method of Operating a Power Supply System Gaving Parallel-connected Inverters, and Power Converting System that comprise multiple DC power generators and multiple DC to AC inverters to form larger power source with one of the inverter is designated as master. It a simple form of scalable power generator, but not intended to be utility grid-tie applications for small solar electrical generator that requires the capability to synchronize with the utility grid's frequency and phase, and to match the voltage to adjust the power to source into the grid. Especially, it is lack of the important capabilities to maximize the solar energy, such as the MPPT (Maximum Power Point Tracking). Also, it is not commercial ready solar electrical generator due to its lack of protection, electricity quality control and communication capabilities.

U.S. Pat. No. 6,219,623 to Wills presents the Anti-islanding Method and Apparatus for Distributed Power Generation. It is a method to stabilize the small generators when connected to utility power grid. It is a general consideration of designing the synchronizing function of the DC to AC inverters for grid-tie electrical generator, not a integrated solar electrical generator.

U.S. Pat. No. 6,046,400 to Drummer presents a Solar Power Supply System that discloses a design about controlling the DC to AC inverter. It is a specific circuit to adjust the output of the AC voltage based on the DC voltage level generated by the solar panels. The design applies to centralized standalone solar electricity supply system with battery backup and not to the integrated, utility power grid-tie generator.

U.S. Pat. No. 5,692,647 to Brodie presents Solar Power Systems for Self-contained Fueling Stations that discloses a design specifically for the standalone fueling station. It is a centralized solar electricity supply system with battery backup, not a small grid-tie solar electrical generator.

U.S. Pat. No. 7,906,934 to Inoue presents Power Source Apparatus and Control Method of the Power Source Apparatus that disclose a specific design about charging battery from solar cells. It applicable for some small standalone remote site power source that charges the battery when the solar energy is available, and supply the electricity to the load from battery when the solar energy is not available or not sufficient. It is not a grid-tie solar electrical generator.

U.S. Pat. No. 7,859,241 to Yoshida presents Photovoltaic Power Generation Controller and Power Evaluation Method in Photovoltaic Power Generation Control that discloses a design about controlling DC to DC converter to perform MPPT (Maximum Power Point Tracking). It applies to the centralized solar electricity power system to dynamically adjust the output power of the system to match the optimal output power form the solar panels. It is not an integrated grid-tie solar electrical generator.

U.S. Pat. No. 7,772,716 to Shaver presents a Distributed Maximum Power Point Tracking System, Structure and Process that discloses a method to maximize the output power of each solar panel or panels. It is used in the centralized solar electricity power system to harvest more solar energy. It is not an integrated grid-tie solar electrical generator.

### SUMMARY OF THE INVENTION

Traditional solar electric power generators are optimized for certain type of applications, such as roof-top, off-grid housing, street-lighting. The capacity of the generator is designed for the specific applications. For example, the roof-top and off-grid housing, the solar generator is designed to provide about 5 KW of electricity. These kinds of generators comprise of about 40 solar panels, a central MPPT controller, a central DC to AC converter, and a grid-tie unit. The generator hardware costs about $25K. This makes sense for the customers who just want to generate the solar electricity for their own use, or because the house is off-grid. However, for the customers who want to generate the solar electricity as investment, these kinds of generators won't work well because it is not scalable. If the customers want to generate more electricity than the designed capacitance of the generator, additional generator has to be installed. Or if the customers like to try to invest in the solar electricity, they have to invest at least $25K for the hardware.

The unique property of solar energy is that it is distributed everywhere. Anyone can put a solar electrical generator on their property and contribute the energy into the utility power grid. With the increasing demands on energy, the price for the electricity will keep going up. In the near future, more and more people would like to do incremental investment on the solar electricity. This invention of Integrated Expandable Grid-Ready Solar Electrical Generator is to address this need. The said generator is fully scalable, from 100 W to a few MW because each generator provides small amount of power, such as 100 W, and any number of generators can be tied together to feed into utility power grid or to be an isolated electrical system to generate more power as needed.

MPPT controller uses the I-V curve of solar panel to determine the maxim output from that panel under certain condition such as the temperature, the sunlight intensity and angle of incidence. In a centralized solar electrical generator, the MPPT controller is not able to provide the optimal performance because there are so many solar panels that are under different sun-light condition. Some could be blocked by trees or other objects, or facing different directions. Plus, the property of solar panel changes with time, the solar panels age differently, so that the performance of centralized solar electrical generator decline quickly. This invention changes this situation. Each solar panel is independent unit, and the integrated MPPT controller adjusts the output only based on this panel's property and condition.

When electric current goes through conduct, part of it will become heat and get lost. The amount of loss depends on intensity of the current and the cross-section area and the type of the conductor. With the same conductor, the loss is proportional to the square of the current. In the centralized solar electrical generator, the electrical energy generated from the solar panel is transported to the central controller and DC to AC converter through a bus-wire as 12V DC. To transport typical 5 KW energy, the bus-wire will carry 416 A. Compare with the generator in this invention. The energy generated from each solar panel is converted to 220V AC. If we transport the same 5 KW energy through the same bus-wire, the current will be only about 22 A, thus the loss will be about 1/335 of the centralized generator.

To reduce the electrical transportation losses in the centralized solar electrical generator, the installer may put a few solar panels in serial to boost the output voltage. However, this creates another problem. When any panel or part of panel in the serialized string is in shade, the output energy of the whole string will be limited by the shaded panel because the solar panel is a current source. Also, when on of the panel is damages, or aged, all the panels in the string will be useless. With this invention, each panel is an independent generator. If one panel or part of it is in shade, or damaged, or aged, it only affects that generator. Also the malfunction panel can be easily identified and replaced to minimize the maintenance efforts, and extend the lifetime of the system much longer.

Although there are some small solar electrical generator on the market, they intended to be used as standalone as isolated electricity source to power up some equipment at remote place. They are designed with certain capability for specific applications, such as the street-light, the remote measurement instrument. Usually, in this kind of generator, the quality of the output is poor; the solar energy utilization efficiency is low and not able to tie to utility grid directly. Also they output 220V or 120V AC, most of them not able to tied together to generate more power because they are not able to synchronize and match the output of the others. The solar electrical generator in this invention integrated with a synchronizing unit that enables the generator to tie to the utility power grid directly. If not tied to utility grid, the generator will work independently to power the load, such as the street-light or equipment. Or more generators can be tied together to form an isolated larger solar electricity source. In this case, they will automatically synchronize with the others.

Some manufacturer may clam they have distributed grid-tie solar MPPT micro-inverter to optimize the output of the attached solar panel. They are too simple to be a robust commercial grade solar electrical generator. The generator in this invention is equipped with much more advanced technologies, such as the DSP based synthetic DC to AC converter to improve the solar energy efficiency and produce very low harmonic 220V or 120V AV power, the active power factor corrector to improve the power quality of the utility power grid at the customer location, the protection relay to provide reliable power source and prevent the generator from interfere the utility grid in case of failure and vice versa, the communication unit to synchronize with the other generators and provide the two-way communication with the remote console for monitoring and control.

### BRIEF DESCRIPTION OF THE DRAWINGS

FIG. 1 is a block diagram of the present invention. It describes the main function blocks of the integrated expandable solar electrical generator. The electrical interconnections are simplified only for the demonstration purpose. The actual connections are far more complex and vary with different options. However, they are not important for the purpose of patent application.

FIG. 2 is solar panel output current vs. voltage under different sunlight. It provides a few typical IV (current vs. voltage) curves that represent how the output current changes with the output voltage, which changes with sunlight. That is the basic theory of MPPT (Maximum Power Point Tracking) that follows the sunlight condition.

FIG. 3 is solar panel output power vs. voltage under different sunlight. It further illustrates the relationship among the maximum power points, the output voltage and the sunlight.

FIG. 4 is solar panel output current vs. voltage under different temperature. It is another property of solar panel that the output voltage changes with the temperature while the output current is kept as constant. As a result, the maximum power points vary with the temperature under the same sunlight. It is another property that the MPPT theory is based on.

FIG. 5 is solar panel output power vs. voltage under different temperature. It further illustrates the relationship among the maximum power point, the output voltage and the temperature.

FIG. 6 is space vector modulation diagram. It is the base for the synthetic DC to AC converter. It is used to calculate the voltage vector based on the phase angle.

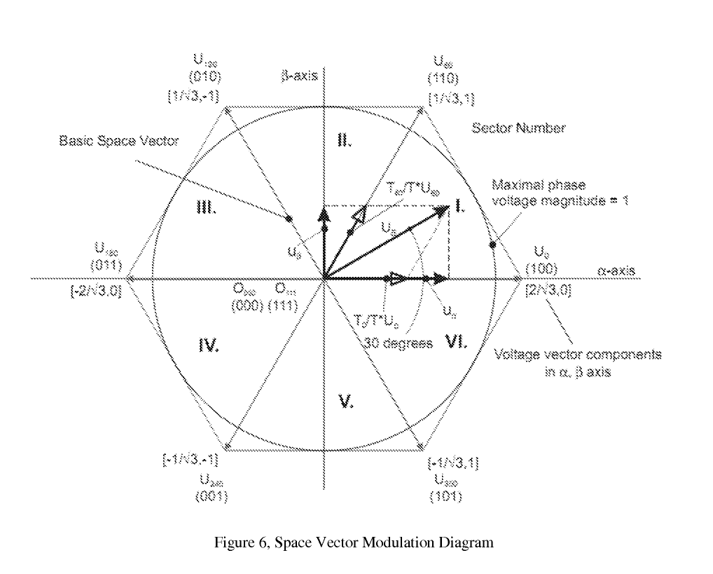

FIG. 7 is output AC waveform with PWM modulation. It illustrates how to synthesis AC with PWM (Pulse Width Modulation). The relationship between the AC waveform and the pulse with is only for the demonstration purpose. It varies with the other configurations in the output circuitry.

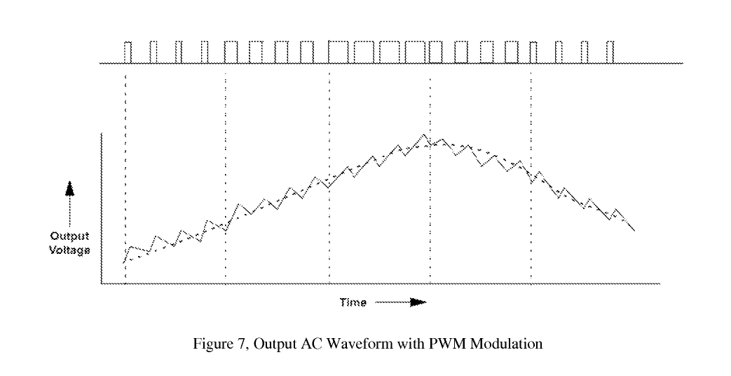

FIG. 8 is schematics of PWM modulation. It is one of the possible configurations for the demonstration purpose to show the major components involved. The actual circuitry may vary depends on the designs and the options.

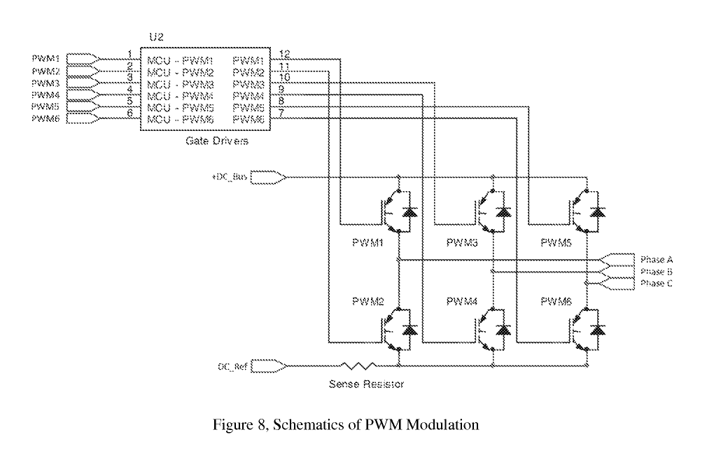

FIG. 9A, FIG. 9B and FIG. 9C are PWM relationship in the 3-phases AC converter. 3-phase AC converter is repeated of three single-phase converters with the fixed phase offset.

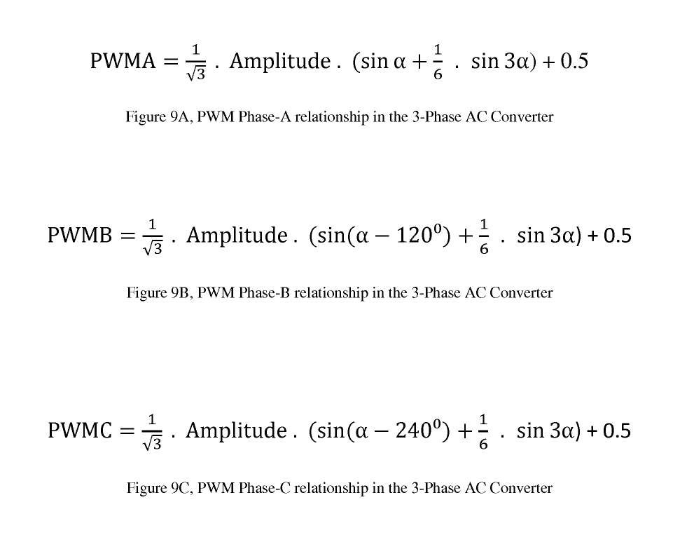

FIG. 10A and FIG. 10B are synthetic 3-phase AC waveform with PWM modulation. It is a simulated waveform represents the typical relationship between the DC bus voltage, the PWM width for each phase, and the final outputs of each phases. The actual waveform may vary with design, the components used and the options.

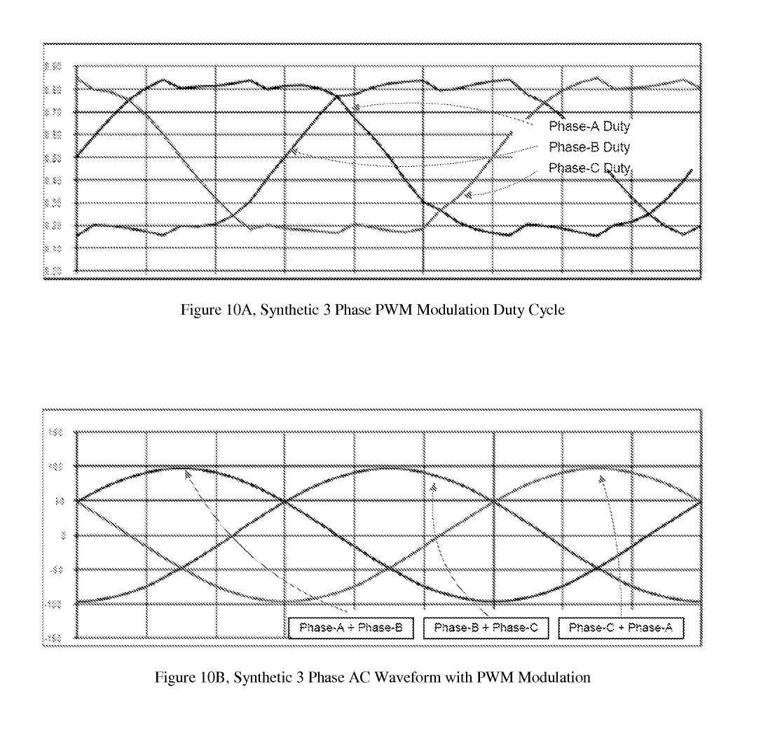

FIG. 11 is 3rd Harmonic component in synthetic 3-phase AC output. It is a simulated waveform represents the typical relationship between the PWM width for each phase, the final outputs of each phases, and the total third harmonic. The actual waveform may vary with design, the components used and the options.

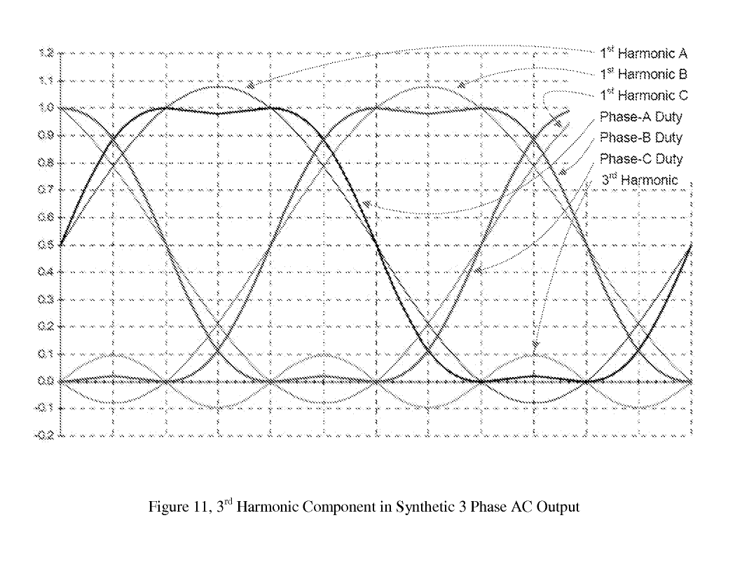

### DETAILED DESCRIPTION OF THE INVENTION

The present invention overcomes many of the prior art problems associated with solar electrical generators that can be directly connected to utility power grid. The features and the advantages of the generator disclosed here will become more apparent to those who have ordinary skill in the art with the following detailed description of the preferred embodiments taken in conjunction with the drawings which set forth representative embodiments of the present invention and wherein reference numerals identify structural elements.

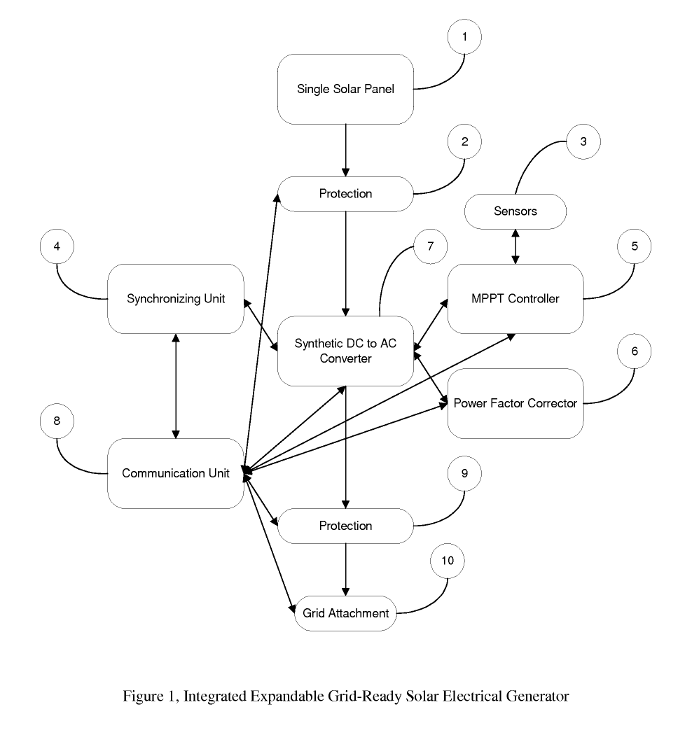

Unit number 1 of the FIG. 1 represents the solar panel. The output power and the output voltage can be in a wide range depends on the application requirements. An example configuration for small remote test instrument is about 20 W with 12V DC output. Another example configuration for commercial solar electrical power plant in open field is about 1000 W with 48VDC output.

Unit number 2 of the FIG. 1 represents the protection devices against the destructive event such as lightning, and isolate the solar panel from the rest of the generator in case of the malfunction of the other function units.

Unit number 3 of the FIG. 1 represents sensors for the temperature, the sunlight, the DC voltage current. It provides the reference point for the MPPT controller and the DC to AC converter.

Unit number 4 of the FIG. 1 represents the synchronizing unit that analyzes the attached power system and determines how to engage with the system, either grid tied or isolated. If there is AC waveform in the power system, the unit will extract the waveform information and inform the DC to AC converter to generate AC waveform accordingly. If there is no electrical power exists in the attached system, the unit will inform the DC to AC converter to generate the default pilot AC waveform with 220V/60 Hz or 120V/50 Hz. In case the conflict detected in the attached system, the unit will inform the DC to AC converter to disengage with the system, and wait for certain amount of time, which depends on the unique serial number of the unit, and try to start over again.

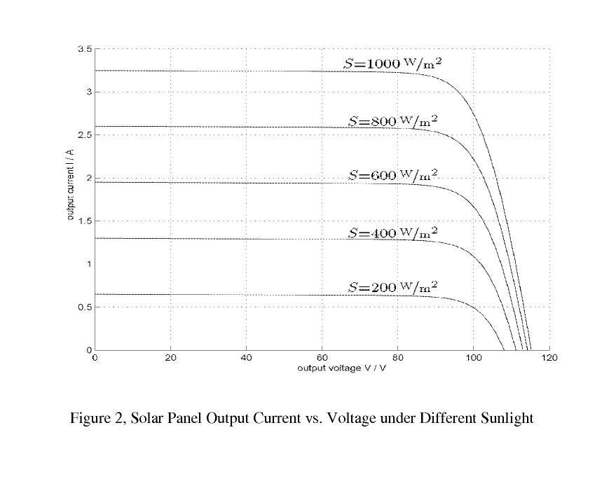

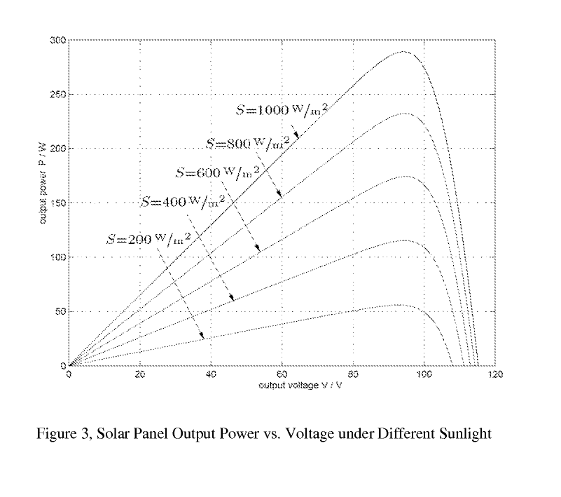

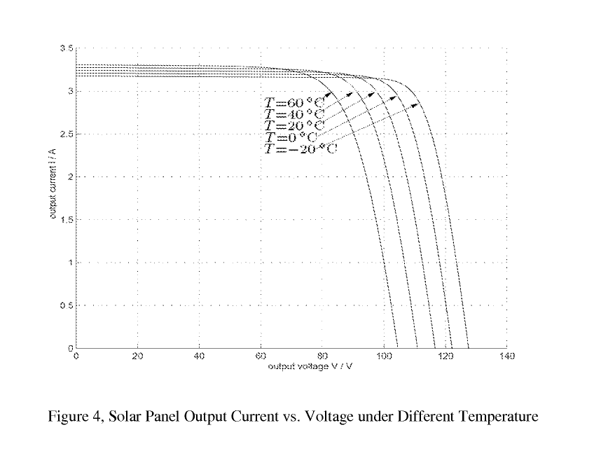

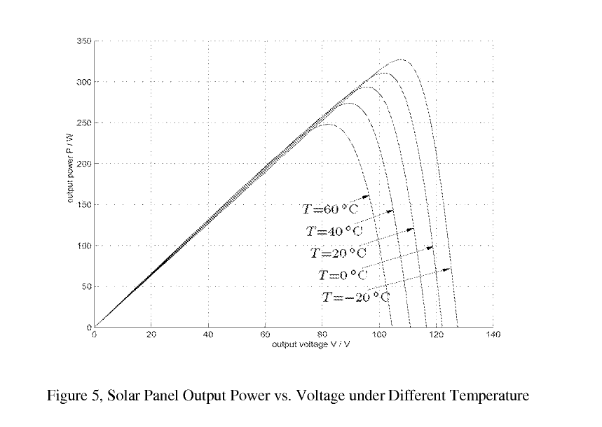

Unit number 5 of the FIG. 1 represents the MPPT (Maximum Power Point Tracking) that calculates the maximum power of the generator can provide. FIG. 2, FIG. 3, FIG. 4 and FIG. 5 are the typical I-V curves that represent the property of the solar panel. They provide the base for the MPPT. At the certain temperature and under certain sunlight, the output current of the solar panel maintains constant to a certain voltage. The output power of the solar panel is determined by the product of the voltage and the current. That means the output power will reach the maximum just before the current started to drop, which is defined as the maximum power point. Since the sunlight can change quickly, such as when the clouds passing by, the MPPT needs to constantly calculate and predict the next maximum power point. The MPPT in this invention uses the current change rate to predict the movement of the maximum power point. The basic algorithm is PID (Proportional Integral and Derivate) control loop with actual output power feedback, plus the correction from the reference sensors. Each of solar panel has different curves, or characteristics, and these characteristics changes over time. For the same solar panel at certain time, the maximum power point varies with the sunlight and temperature. However, the MPPT unit needs to calibrate the curve from time to time to keep tracking the aging process.

Unit number 6 of the FIG. 1 represents the power factor corrector that constantly uses FFT (Fast Fourier Transform) to analyze phase angle and harmonic components in the voltage and current of the engaged AC power system. If the phase angle in the voltage and current is offset, this unit informs the DC to AC converter to offset the angle in the opposite direction. If the harmonic components are out of certain range, this unit informs the DC to AC converter to modify the PWM algorithm to produce the inverted harmonic to cancel out the harmonic in the power system. The power factor is the important measurement for the power quality.

Unit number 7 of the FIG. 1 represents the synthetic DC to AC converter with advances harmonic reduction technologies to efficiently produce low harmonic high quality AC power that is synchronized with the utility power grid or with the other similar generators. It receives the information from the synchronizing unit to set the phase angle and the amplitude in the space-vector, and calculates the real-time PWM width to produce the AC waveform. After the generated waveform matches the required waveform, the output will be engaged with the utility power grid or the isolated power system. Once engaged, the generator will get the control signal from the MPPT controller to determine the amplitude of the AC wave that represents the maximum power the generator can provide. Also, this converter gets the control signals from the power factor corrector to shift the phase of the output AV waveform to inject certain amount of VAR to improve the power factor. DC to AC converter is DSP (Digital Signal Process) technologies based synthetic DC to AC converter. It is able synthesis any waveform needed. The power factor corrector also continuously does Fourier transformation to analyze the harmonic components of the AC waveform and informs the converter modify the PWM value to generate opposite harmonics to cancel the harmonics in the AC power. For the small solar electrical power sources, like the roof-top applications, these small generators will improve the power quality very effectively because they are at the location where the power is used.

Unit number 8 of the FIG. 1 represents the communication unit that collects the data from all the major function blocks, such as the DC voltage and the current from MPPT and output power from the DC to AC converter, and communicates with the remote control/monitor console or the other generators in the system by means of power wire connection or wireless connection. The power wire connection is a proprietary protocol based on 100 KHz synchronous FSK for 220V/50 Hz system or 120 KHz synchronous FSK for 110/60 Hz system. The wireless connection is based on standard IEEE802.15.4, or IEEE802.15.1.

Unit number 9 of the FIG. 1 represents the protection devices against the destructive event such as lightning and power failure, and isolate the solar panel from the rest of the generator in case of the malfunction of the other function units.

Unit number 10 of the FIG. 1 represents the device that is made to attach to the electrical power grid easily. There different configurations depends on the type of the applications. One configuration can be a NEMA 5-15R 120V AC power receptacle for US market, or BS 1363 220V AC power receptacle for UK market and CPCS-CCC 220V AC power receptacle for Chinese market. Also, the device can be an electric terminal to attach to the junction box, or an electric clamp to attach to bus-wire.

1. An integrated expandable grid-ready electrical generator comprise a solar panel, a Max Power Point Tracking (MPPT) controller, a high efficiency low harmonic digital signal process (DSP) technology based synthetic DC to AC converter, a grid synchronizing controller, a power factor compensation unit, a protection unit, an energy meter, and a communication unit.

2. The generator of claim 1 outputs 220V or 120V AC and can be directly connected to utility power grid, connected to a standalone load, or connected to more generators to provide more electrical power.

3. The generator of claim 1, wherein said solar panel can be made either from crystalline silicon or thin-film cells.

4. The module of claim 3, wherein said cells can be configured to have total power ranging from 10 W to 1000 W to meet the requirements for different applications.

5. The generator of claim 1, wherein said MPPT controller uses advanced algorithm to predict the maxim power point of the solar panel shall work at.

6. The generator of claim 1, wherein said high efficiency low harmonic digital signal process (DSP) technology based synthetic DC to AC converter utilizes space vector modulation and other algorithm to produce high quality 220V or 120V AC power.

7. The DC to AC converter of claim 6, wherein said 220V or 120V AC power is synchronized with utility grid and source the maximum power into grid when directly tied to the grid or is synchronized with the other generators to source the power that the load needed when used as isolated power system.

8. The generator of claim 1, wherein said communication unit can be configured as wireless unit based on IEEE802.15.4, or IEEE802.15.1; or as power-line unit based on proprietary communication protocol.

9. The generator of claim 1, wherein said power factor compensation unit is an active power factor corrector.

10. The generator of claim 1 can be optionally equipped with battery or batteries to fit some special standalone applications.
